(19) United States
(12) Patent Application Publication
(10) Pub. No.: US 2008/0260165 A1
(43) Pub. Date: Oct. 23, 2008

(54) DIGITAL MODULATOR AND DIGITAL MODULATING METHOD

(75) Inventors: Koji SAITO, Kyoto (JP); Hisashi FURUMOTO, Kyoto (JP)

Correspondence Address: CANTOR COLBURN, LLP, 20 Church Street, 22nd Floor, Hartford, CT, 06103, US

(73) Assignee: ROHM CO., LTD., Kyoto (JP)

(21) Appl. No.: 12/025,304

(22) Filed: Feb. 4, 2008

(30) Foreign Application Priority Data
Feb. 2, 2007 (JP) JP2007-023727
Nov. 29, 2007 (JP) JP2007-309095

(51) Int. Cl. H04H 20/48; H04L 27/20

(52) U.S. Cl. 381/3; 332/103

(57) ABSTRACT

A digital modulator performs BPSK on differential data, filters it, and outputs the resultant data. A determining unit determines a combination of continuous two values of differential data. In a waveform generator, waveform generation rules are set for each of the combinations. On the basis of the waveform generation rule corresponding to the combination determined by the data determining unit, the waveform generator sequentially outputs a digital waveform signal.

### BACKGROUND OF THE INVENTION

1. Field of the Invention

The present invention relates to a digital modulator for phase-shift-keying a digital signal, filtering the resultant signal, and outputting the filtered signal.

2. Description of the Related Art

In recent years, an FM radio station in Europe and a radio broadcast station in U.S. transmit additional information such as text as information in an RDS (Radio Data System) in Europe or RBDS (Radio Broadcast Data System) in U.S. By using the RDS/RBDS, in a receiver such as a car radio, various information such as the name of a broadcast station which is presently tuned, genre of music, and the like can be used (Japanese Patent Application (Laid Open) Nos. H8-256135 and H8-191232).

On the other hand, an FM transmitter for converting an audio signal to a stereo composite signal, performing frequency modulation by using a frequency modulator, and outputting the frequency-modulated signal is known (Japanese Patent Application (Laid Open) Nos. H9-069729, H10-013370 and H9-312588). By using the FM transmitter, the audio signal can be transmitted without using a wire such as an RCA cable. Consequently, the FM transmitter can be used for transmitting signals between a CD changer in a car audio system and a head unit. Moreover, in recent years, a hard disk audio device, a memory audio device, and a cellular phone terminal having the music reproduction function are markedly being spread. The FM transmitter is used also for the application of reproducing music data stored in such a small electronic device from a speaker of a stationary audio component or the like.

Related Document List
1. Japanese Patent Application (Laid Open) No. H9-069729
2. Japanese Patent Application (Laid Open) No. H10-013370
3. Japanese Patent Application (Laid Open) H9-312588
4. National Radio Systems Committee, “United States RBDS Standard”, U.S., Apr. 9, 1998

A method of modulating RDS/RBDS data will be examined. Generally, a modulator is constructed by a differential encoder, a phase-shift keying modulator, a filter, and an amplitude modulator. The differential encoder receives RDS/RBDS data and differential-encodes it. The phase-shift keying modulator performs binary phase-shift keying (BPSK) on the differential-encoded signal. From the signal subjected to the BPSK, high frequency components are removed by a filter for spectrum shaping. The amplitude modulator modulates the amplitude of a sub-carrier of 57 kHz using an output of the filter as a modulation signal.

When an analog filter is used as the filter for filtering the signal subjected to the BPSK, the circuit scale enlarges. When circuit elements of the filter vary, there is the possibility that an error rate deteriorates and an adverse influence is exerted on a stereo modulation signal. In the case of using a digital filter, there are problems such that power consumption increases and the circuit area enlarges.

There is a case that the filter is used for shaping the spectrum of data subjected to the phase-shift keying other than modulation of the RDS/RBDS data. In this case as well, similar problems occur.

### SUMMARY OF THE INVENTION

The present invention has been achieved in view of such problems and a general purpose of the invention is to provide a digital modulator capable of performing phase-shift keying and filtering.

An embodiment of the present invention relates to a digital modulator that performs PSK (phase-shift keying) on input digital data, filters it, and outputs the resultant data. The digital modulator includes: a data determining unit that determines a combination of two or more continuous values of the input digital data; and a waveform generator in which a waveform generation rule is set for each of combinations and which sequentially outputs a digital waveform signal on the basis of a waveform generation rule corresponding to the combination determined by the data determining unit.

In the embodiment, a filtering process by a digital or analog filter is not performed but the waveform generation rule for specifying a waveform after filtering (filter process) is set. As a result, a filter circuit is unnecessary, and PSK and filtering can be performed easily. It is desirable to hold, as the waveform generation rule, a rule for generating a waveform obtained by approximating a waveform to be inherently output.

The waveform generator may include a memory in which waveform data of a trigonometric function is recorded. The waveform generator may read the waveform data of the trigonometric function, perform a predetermined computation on the waveform data in accordance with the combination of the data, and output the resultant data.

The waveform generation rule may be specified by linear sum of waveform data of trigonometric functions of different frequencies.

In this case, the waveforms after filtering can be approximated by Fourier series expansion.

When the input digital data is 1-bit data of 1 or 0, a combination of continuous two pieces of input digital data is expressed as (D1, D2), and the waveform data of the trigonometric function of a reference frequency is expressed as sin(ωt) (ωt denotes a variable), the data determining unit determines any of (0, 0), (0, 1), (1, 0), and (1, 1), and the waveform generation rule for generating a digital waveform signal “y” is specified as follows when α1, α2, and β are constants, y=α1·sin(ωt) for (0, 0), y=α2·sin(0.5ωt)+β(sin 1.5ωt) for (0, 1), y=−α2·sin(0.5ωt)−β(sin 1.5ωt) for (1, 0), and y=−α1·sin(ωt) for (1, 1).

α1:α2:β may be about 1:1:0.25.

The input digital data is 1-bit data of 1 or 0, PSK is BPSK (binary PSK), when a cycle signal whose phase is shifted according to the input digital data passes the value 0 every cycle, each of digital waveform signals generated by the waveform generator may be data expressing an interval between time when the cycle signal passes the value 0 in a certain cycle and time when the cycle signal passes the value 0 in the next cycle. A signal which is subject to BPSK passes the middle of the cycle, that is, the value 0 as an average value of direct currents. In other words, transition between the high level and the low level occurs. Therefore, each of the digital waveform signals can be expressed as a waveform whose both ends pass the value 0. It is convenient since there are cases in which the number of waveforms to be specified by the rule can be decreased.

The digital modulator may further include a differential encoder that differentially encodes a digital signal of one bit. The data determining unit may receive an output of the differential encoder as the input digital data.

The digital signal of one bit may be RDS (Radio Data System) data or RBDS (Radio Broadcast Data System) data.

The digital modulator may further include an amplitude modulator that receives a waveform signal from the waveform generator and modulates a carrier using the waveform signal as a modulation signal.

The digital modulator may be monolithically integrated on a single semiconductor substrate.

Another embodiment of the present invention relates to an FM transmitter. The FM transmitter includes: a stereo modulator that converts an audio signal to a stereo composite signal; the above-described digital modulator that receives RDS/RBDS data, performs differential encoding, BPSK, and filtering on the received data, and outputs the resultant data; an adder that adds an output signal of the digital modulator and the stereo composite signal output from the stereo modulator; and a frequency modulator that receives an output signal of the adder and modulates a carrier using the received output signal as a modulation signal.

In the another embodiment, it is unnecessary to provide a digital filter and an analog filter, so that the circuits can be simplified.

Further another embodiment of the present invention relates to an electronic device. The electronic device includes: a sound source that outputs an audio signal; a host processor that generates RDS/RBDS data; and the above-described FM transmitter that is connected to the sound source and the host processor via a predetermined bus, receives the audio signal and the RDS/RBDS data, frequency-modulates the data, and outputs the frequency-modulated data.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram showing a configuration of an electronic device on which an FM transmitter of an embodiment of the invention is mounted;

FIG. 2 is a block diagram showing the configuration of a digital modulator in FIG. 1;

FIG. 3 is a diagram showing a waveform generation rule which is set in a computing unit in FIG. 2;

FIG. 4 is a time chart showing operations of the digital modulator in FIG. 2; and

FIG. 5 is a circuit diagram of an FM transmitter and peripheral circuits.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the specification, “a state where a member A is connected to a member B” includes the case where the members A and B are physically directly connected to each other, and the case where the members A and B are indirectly connected to each other via another member which does not exert an influence on the electric connection state.

Similarly, “a state where a member C is provided between the members A and B” includes the case where the members A and C or the members B and C are directly connected to each other and the case where the members A and C or the members B and C are indirectly connected to each other via another member which does not exert an influence on the electric connection state.

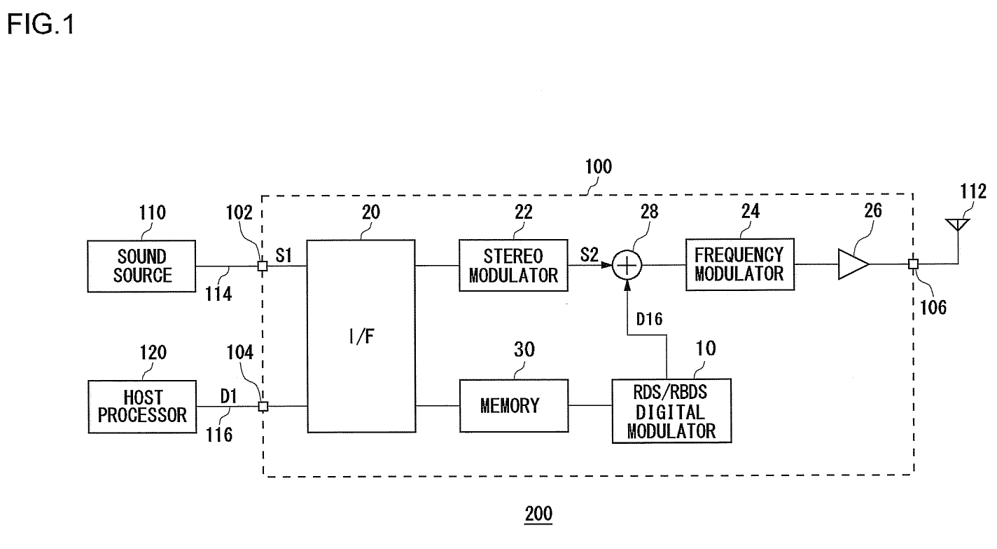

FIG. 1 is a block diagram showing a configuration of an electronic device 200 on which an FM transmitter 100 of an embodiment of the invention is mounted. The electronic device 200 is, for example, a cellular phone terminal, a radio receiver, or a silicon audio player, and has an audio reproduction function. An audio signal to be reproduced can be output from an electroacoustic transducer itself such as a speaker or earphone of the electronic device 200. In addition, the electronic device 200 can frequency-modulate an audio signal and transmit the frequency-modulated audio signal as electric waves to the outside in order to realize higher sound-quality audio reproduction. The user can receive the transmitted signal by an external audio player and reproduce the received signal with higher sound quality.

The FM transmitter 100 of the embodiment can transmit not only the audio data but also character data and the like. Consequently, the FM transmitter 100 and a host processor 120 generate signals conformed to the RDS/RBDS. The RDS/RBDS denotes “RDS and/or RBDS”.

The electronic device 200 includes a sound source 110, the host processor 120, the FM transmitter 100, and an antenna 112. The sound source 110 and the host processor 120 may be the same IC.

The sound source 110 outputs an audio signal S1. For example, the audio signal S1 may be a signal obtained by receiving and demodulating broadcast waves or a signal obtained by reproducing data stored in a memory. Any method may be used to generate the audio signal S1. The sound source 110 and the FM transmitter 100 are connected to each other via a bus 114 of a predetermined format. For example, the bus 114 is an I2S bus. In this case, the audio signal S1 is transmitted as serial data between the sound source 110 and the FM transmitter 100.

The FM transmitter 100 receives the audio signal S1 from the sound source 110. The FM transmitter 100 has an interface unit 20, a stereo modulator 22, a frequency modulator 24, a power amplifier 26, a memory 30, and a digital modulator 10 which are monolithically integrated on a single semiconductor substrate as a functional integrated circuit (IC). FIG. 1 shows only main circuit blocks extracted, and the other blocks are appropriately not shown.

The interface unit 20 receives the audio signal S1 from the sound source 110 via an input terminal 102. The interface unit 20 receives the audio signal S1 and outputs the signal to the stereo modulator 22. The stereo modulator 22 performs stereo modulation on the audio signal S1, thereby generating a stereo composite signal S2.

The details of the RDS/RBDS described in National Radio Systems Committee, “United States RBDS Standard”, U.S., Apr. 9, 1998 and the like can be referred to. The host processor 120 outputs data D1 to be transmitted as RDS/RBDS. The data D1 itself to be transmitted is not in an RDS/RBDS format but is just text data. The host processor 120 and the FM transmitter 100 are connected to each other via a bus 116 of a predetermined format. For example, the bus 116 is an I2C bus. The interface unit 20 receives the data D1 input to an input terminal 104 via the bus 116. The data D1 is additional data to be transmitted together with the audio signal S1 from the antenna 112. Desirably, data is transmitted from the host processor 120 to the FM transmitter 100 only at a timing when RDS/RBDS data to be transmitted from the antenna 112 is changed. In this case, only at the time of changing data, the data in the memory 30 is updated.

The memory 30 is constructed by a register or the like and stores the data D1 received by the interface unit 20. In the RDS/RBDS format, the same data is repeatedly transmitted. The host processor 120 outputs data as a unit of repetition in a lump to the FM transmitter 100.

The digital modulator 10 sequentially reads the data D1 stored in the memory 30, performs binary phase-shift keying on the read data, filters it, and outputs the resultant data. An adder 28 adds RDS/RBDS data D16 output from the digital modulator 10 to the stereo composite signal S2. The frequency modulator 24 modulates the frequency of a carrier using an output of the adder 28 as a modulation signal. The power amplifier 26 amplifies an output of the frequency modulator 24 and outputs the amplified output to the antenna 112 on the outside via an output terminal 106.

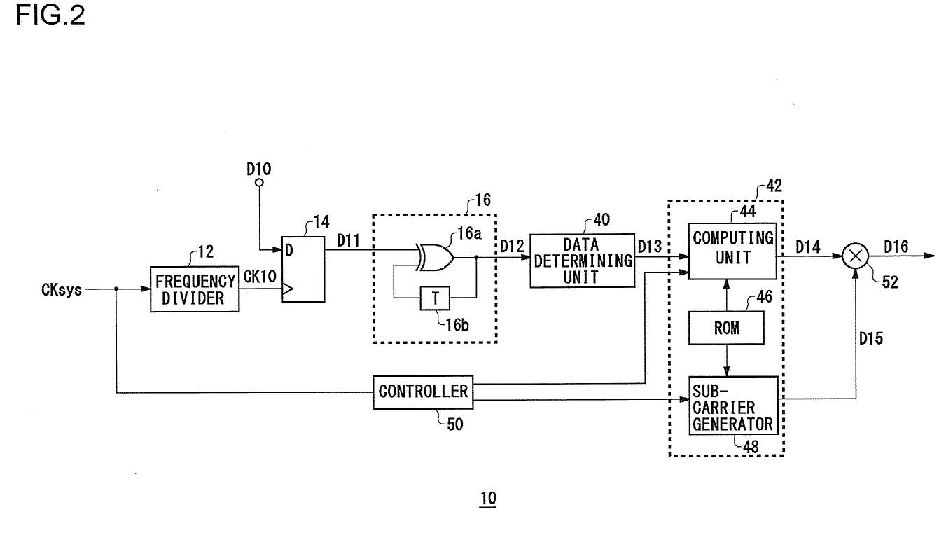

The outline of the configuration of the FM transmitter 100 has been described above. The configuration and operation of the digital modulator 10 will be described below. FIG. 2 is a block diagram showing the configuration of the digital modulator 10 of FIG. 1.

The digital modulator 10 includes a frequency divider 12, an input buffer 14, a differential encoder 16, a data determining unit 40, a waveform generator 42, a controller 50, and an amplitude modulator 52.

To the digital modulator 10, input data D10 read bit by bit from the memory 30 in FIG. 1 is sequentially entered. The bit rate of the input data D10 is 1.1875 kHz. The digital modulator 10 performs PSK (Phase-shift keying) on the input data D10, filters it, and outputs the resultant data. To be specific, the PSK is BPSK.

A system clock CKsys is input to the frequency divider 12. The frequency divider 12 divides the frequency of the system clock CKsys, thereby generating a reference clock CK10 having the same frequency as that of the input data D10. The input buffer 14 receives the input data D10 and the reference clock CK10. The input buffer 14 is constructed by, for example, a flip flop or a latch circuit. In the case of the flip flop, the value of the input data D10 is latched at every positive edge of the reference clock CK10. The output data of the input buffer 14 (hereinbelow, called input data D11) is input to the differential encoder 16. The differential encoder 16 differentially encodes the input data D11. The differential encoder 16 includes an exclusive-OR gate (hereinbelow, called XOR gate) 16a and a delay circuit 16b. The delay circuit 16b delays an output of the XOR gate 16a only by one piece of data, that is, one cycle of the reference clock CK10. The XOR gate 16a outputs an exclusive OR of the output of the delay circuit 16b and the input data D11. Output data (hereinbelow, called differential data) D12 of the differential encoder 16 is differentially encoded data.

The data determining unit 40 receives the differential data D12. The data determining unit 40 determines combination of values of “n” pieces of continuous differential data D12. There are 2ⁿ combinations of the differential data D12. In the following, the case of determining a combination of four pieces of differential data with respect to continuous “n” pieces (n=2) will be described.

The data determining unit 40 generates combination data D13 indicative of the determined combination of differential data D12. The differential data D12 is 1-bit data of 1 or 0. A combination of the two continuous differential data D12 will be expressed as (D1, D2). The combination data D13 indicates any of (0, 0), (0, 1), (1, 0), and (1, 1).

The waveform generator 42 receives the combination data D13. In the waveform generator 42, waveform generation rules are set for each of the four combinations (0, 0), (0, 1), (1, 0), and (1, 1). The waveform generator 42 sequentially outputs digital waveform signals D14 on the basis of the waveform generation rule corresponding to the combination determined by the data determining unit 40.

The waveform generator 42 includes a computing unit 44, a ROM 46, and a sub-carrier generator 48. The computing unit 44 and the ROM 46 generate the digital waveform signal D14. The sub-carrier generator 48 and the ROM 46 generate a sub-carrier D15 of 57 kHz.

The ROM 46 records waveform data of trigonometrical function. In place of the ROM, a hard disk or the like may be used. The computing unit 44 reads the waveform data of trigonometrical function, performs predetermined computation according to the combination data D13, and outputs the resultant data.

The waveform data of trigonometrical function recorded on the ROM 46 is expressed as sin(ωt). ωt denotes a variable. The waveform data is quantized to a digital value.

The waveform generation rule for generating the digital waveform signal D14 may be specified as follows when the value of the digital waveform signal D14 is expressed as “y” and α1, α2, and β are constants.

y=α1·sin(ωt) for D13=(0, 0)

y=α2·sin(0.5ωt)+β(sin 1.5ωt) for D13=(0, 1)

y=−α2·sin(0.5ωt)−β(sin 1.5ωt) for D13=(1, 0)

y=−α1·sin(ωt) for D13=(1, 1)

ω denotes angular frequency of the reference clock CK10, and t denotes time. That is, the waveform generation rule is specified by linear sum of waveform data of trigonometrical functions of different frequencies. It means that a waveform to be generated is approximated by Fourier series expansion. Preferably, α1:α2:β is set to 1:1:0.25 or similar values.

In the following description, it is assumed that α1=α2=1, and β=0.25 are satisfied. When α1=α2=1 is established, substantial multiplying process is unnecessary. When β=0.25 is satisfied, bit shifting is sufficient. There is consequently an advantage that multiplication is unnecessary. Since the circuit area of a multiplier is large, the effect of reduction in the circuit area is large. However, in the case where higher precision of waveform approximation is desired, other values may be set as α1, α2, and β. In this case, in exchange for simplification of the circuit configuration, the precision of the digital waveform signal D14 can be increased.

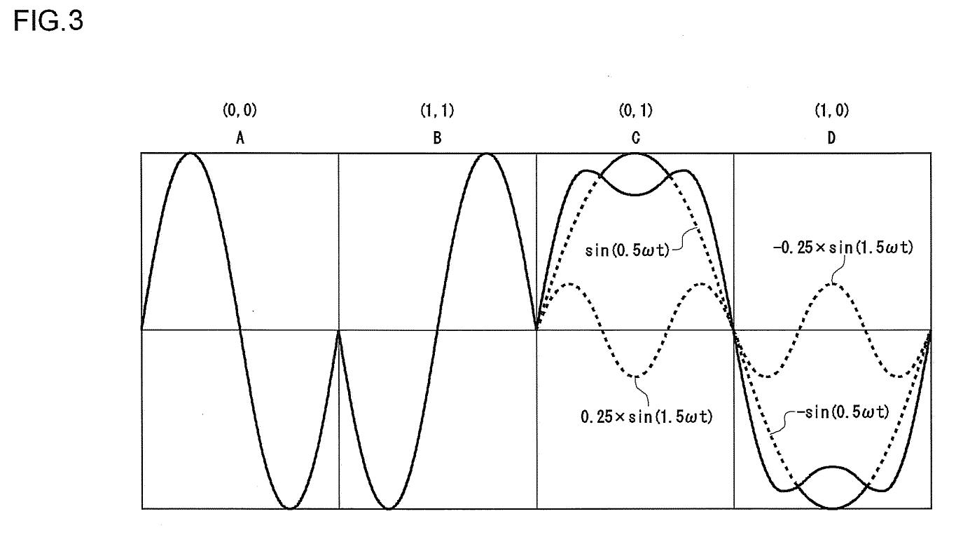

FIG. 3 is a diagram showing a waveform generation rule which is set in the computing unit 44. In the diagram, solid lines A to D show waveforms of the digital waveform signal D14 corresponding to the combinations (0, 0), (1, 1), (0, 1), and (1, 0).

Referring again to FIG. 2, the controller 50 receives the system clock CKsys and controls the computing unit 44 and the sub-carrier generator 48. The controller 50 manages time “t” by counting the system clocks CKsys. The computing unit 44 reads the value of sin(ωt) corresponding to the time “t”. The computing unit 44 may include an address decoder for receiving the variable “t” and reading the value of sin(ωt) corresponding to the variable “t”.

The sub-carrier generator 48 generates the sub-carrier D15 of ω=2π×fs by using the waveform data sin(ωt) recorded on the ROM 46. fs is equal to 57 kHz. Like the computing unit 44, the sub-carrier generator 48 includes an address decoder. The amplitude modulator 52 is, for example, a mixer. The amplitude modulator 52 receives the digital waveform signal D14 from the waveform generator 42 and, using the signal as a modulation signal, modulates the sub-carrier D15. An output of the amplitude modulator 52 is the RDS/RBDS data D16.

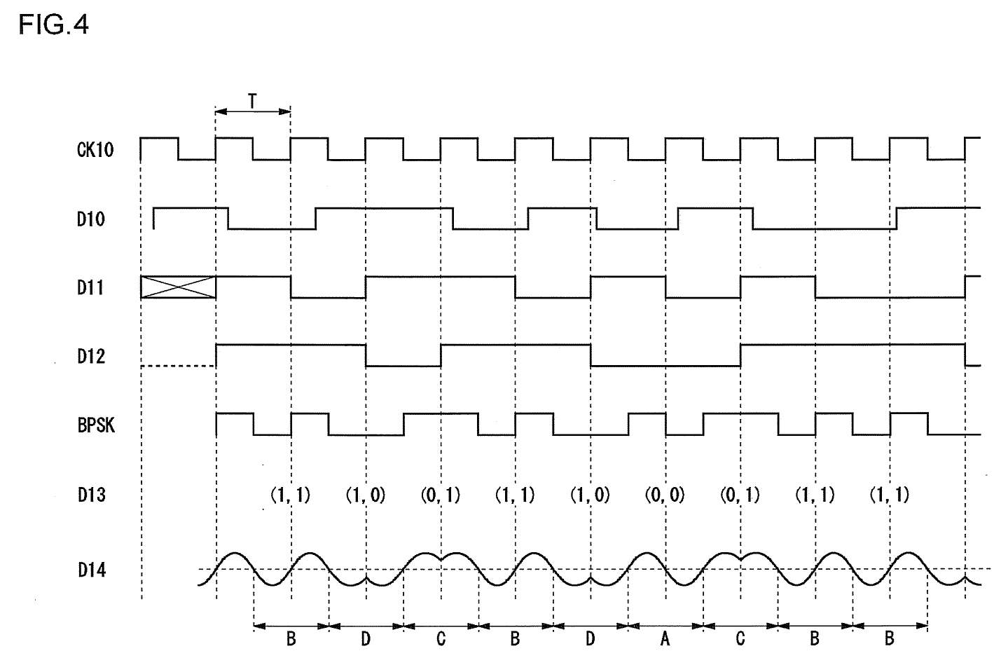

FIG. 4 is a time chart showing operation of the digital modulator 10 of FIG. 2 of the embodiment. By the input buffer 14, the input data D11 is synchronized with the reference clock CK10. The input data D11 has the value of the input data D10 at the timing of the positive edge of the reference clock CK10.

The differential data D12 is data obtained by differentially encoding the input data D11. That is, when the value of the input data D11 at time n-T corresponding to a reference clock CK10 and the value of the differential data D12 at time (n−1)·T corresponding to the immediately preceding reference clock CK10 coincide with each other, the differential data D12 at the time n-T becomes the low level (0). When they do not coincide with each other, the differential data D12 becomes the high level (1). T denotes the cycle of the reference clock CK10.

The signal BPSK in FIG. 4 denotes a signal obtained by performing binary phase-shift keying on the differential data D12. The phase of the signal BPSK when the differential data D12 is 1 and that of the signal BPSK when the differential data D12 is 0 are shifted from each other by 180 degrees. The signal BPSK is not actually generated in the digital modulator 10 but is shown for explaining the circuit process. The digital waveform signal D14 shows the waveform to be generated by performing filtering process with a low-pass filter on the signal BPSK. The digital modulator 10 of the embodiment does not generate the signal BPSK and filters it, but directly generates the digital waveform signal D14 without generation of the signal BPSK.

The combination data D13 is any of (0, 0), (0, 1), (1, 0), and (1, 1) in accordance with two continuous values of differential data D12. According to the combination data D13, the waveform generator 42 generates the digital waveform signal D14 by sequentially generating any of the waveforms A to D.

The configuration and operation of the digital modulator 10 have been described above. The digital modulator 10 of the embodiment does not perform a filtering process by a digital or analog filter but sets the rule for generating a waveform approximated to a waveform to be output after the filtering (filter process). As a result, a filter circuit is unnecessary, and PSK and filtering can be performed easily.

If the filter is formed by an analog circuit, the number of circuit parts increases. Further, a waveform to be generated is influenced by variations in circuit parts, and a problem that the error rate deteriorates arises. When the cut-off frequency of the filter increases due to the variations, a problem occurs such that the spectrum of RDS/RBDS data of about 57 kHz is leaked to a stereo modulation signal of about 38 kHz.

In contrast, in the digital modulator 10 of the embodiment, no filter is required, so that increase in the circuit area can be suppressed. Further, the cut-off frequency of the filter does not vary, so that the influence on the stereo modulation signal can be also suppressed.

In the case of constructing the filter by a digital circuit, the computation precision is requested, so that the circuit scale and the power consumption increase. The digital modulator 10 of the embodiment can solve the problem.

The waveform generation rule is specified by linear sum of the waveform data of trigonometrical functions of different frequencies. Consequently, a waveform subjected to filtering can be approximated by Fourier series expansion. Although the approximation is performed by linear sum of three sine waves of different frequencies in the embodiment, a sine wave of higher degree may be included. Also by approximation using a cosine wave “cos” in place of or in addition to the sine wave “sin”, similar effects can be obtained. Depending on a waveform to be approximated, there is the case where use of the cosine wave “cos” is appropriate.

In the embodiment, the signal BPSK in FIG. 4 is a cycle signal whose phase is shifted according to the differential data D12. The signal BPSK passes the value 0 at intermediate time T/2 every cycle. T denotes the cycle of the signal BPSK. In this case, it should be noted that the digital waveform signals D14 (A to D) generated by the waveform generator 42 are data expressing an interval between time when the cycle signal BPSK passes the value 0 in a certain cycle and time when the cycle signal BPSK passes the value 0 in the next cycle.

If the digital waveform signal D14 is generated by associating one cycle of the signal BPSK (or the reference clock CK10) with the same interval, the digital waveform signal D14 is determined by continuous three values (n=3) of differential data D12, so that it is necessary to specify 2³=8 waveform generation rules. Further, in this case, the data determining unit 40 has to monitor the three continuous differential data D12 and determine the combination of the data.

In contrast, in the embodiment, an interval is set by neighboring points at each of which the signal BPSK passes through the value 0, and the waveform is approximated. Thus, the number of waveforms to be prepared can be decreased.

The case of specifying eight waveform generation rules and generating the digital waveform signal D14 is also included in the scope of the present invention.

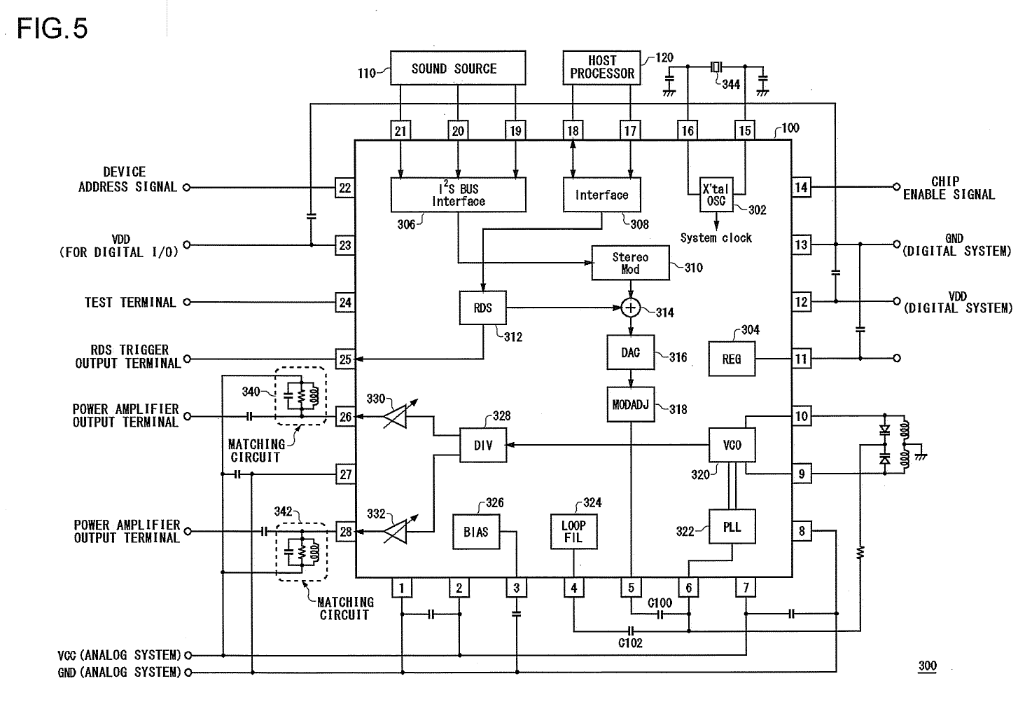

FIG. 5 is a circuit diagram of the FM transmitter 100 and peripheral circuits. The IC of the FM transmitter 100 has first to 28^{th} pins.

To the first, second, seventh, eighth, and twenty-seventh pins, the power supply voltage Vcc for analog circuits in the FM transmitter 100 and the ground voltage GND are supplied. To the 12^{th}, 13^{th}, and 23^{rd} pins, the power supply voltage Vdd for digital circuits and the ground voltage GND are supplied.

A regulator 304 generates voltage used in an internal logic of the FM transmitter 100. From the 11^{th} pin, the voltage generated by the regulator 304 is output.

To the 19^{th} to 21^{st} pins, the sound source 110 is connected via the I2S bus. The 19^{th} pin is for data, the 20^{th} pin is for clocks, and the 21^{st} pin is for LR clocks. An I2S bus interface unit 306 transmits/receives data to/from the sound source 110.

To the 17^{th} and 18^{th} pins, the host processor 120 is connected via the I2C bus. The 17^{th} pin is for a clock signal, and the 18^{th} pin is for a data signal.

To the 15^{th} and 16^{th} pins, a crystal oscillator 344 is connected. An oscillator 302 provides a system clock.

A chip enable signal is input to the 14^{th} pin. By the chip enable signal, the FM transmitter 100 is switched between a normal operation mode and a power-down mode. In the power-down mode, internal circuits are shut down, current consumption becomes almost zero, and signals from the outside are not accepted.

To the 22^{nd} pin, a device address selection signal is input. When an LSI controlled by a common I2C bus exists other than the FM transmitter 100, the 22^{nd} pin is provided to distinguish between the FM transmitter and the LSI. The 24^{th} pin is a terminal for test.

The 25^{th} pin is a trigger output signal for RDS. An RDS digital modulator 312 notifies the circuit blocks other than the FM transmitter 100 via the 25^{th} pin of the fact that an RDS signal is transmitted from the outside to the FM transmitter 100.

A stereo modulator 310 receives an audio signal received from the sound source 110 and stereo-modulates the audio signal, thereby generating a stereo composite signal. The RDS digital modulator 312 sequentially reads data from the host processor 120, performs binary phase-shift keying, filters it, and outputs the resultant data. An adder 314 adds RDS/RBDS data output from the RDS digital modulator 312 to the stereo composite signal.

A DAC 316 digital-analog-converts an output of the adder 314. The amplitude of the DAC 316 is adjusted by a modulation degree adjuster 318, and the resultant data is supplied to a PLL 322 via the fifth pin, an external capacitor C100, and the sixth pin. The sixth pin is connected to a loop filter 324 via a capacitor C102 and the fourth pin (PLL time constant switching terminal). The loop filter 324 is formed by the capacitor C102 connected to the fourth pin and a not-shown resistor in the FM transmitter 100. By changing the capacitance value of the capacitor C102 or changing the resistance value, the time constant is adjusted.

A VCO 320 oscillates at a frequency according to a signal from the PLL and supplies a FM-modulated signal to a divider 328. To the VCO 320, a variable capacitance diode and an inductor are connected via the ninth and tenth pins.

The FM transmitter 100 has power amplifiers of two systems. The divider 328 outputs signals to power amplifiers 330 and 332. An output of the power amplifier 330 is output from the 26^{th} pin to the outside. To the 26^{th} pin, a matching circuit 340 is connected. An output of the power amplifier 332 is supplied from the 28^{th} pin to the outside. To the 28^{th} pin, a matching circuit 342 is connected. By providing the two systems of the power amplifiers and matching circuits, the frequency characteristic can be adjusted according to a load (antenna) of each of the systems.

The correspondence between FIGS. 1 and 5 is as follows.

Interface unit 20: interfaces 306 and 308
Digital modulator 10: RDS 312
Adder 28: adder 314
Frequency modulator 24: DAC 316, modulation degree adjuster 318, loop filter 324, PLL 322, and VCO 320
Power amplifier 26: divider 328 and power amplifiers 330 and 332

The present invention has been described above on the basis of the embodiment. It is to be understood by a person skilled in the art that the embodiment is illustrative and the combination of the components and processes of the embodiment can be variously modified, and such modifications are also in the scope of the present invention. The modifications will be described below.

Although the waveform generator 42 includes the ROM 46 recording waveform data of trigonometrical function as a base, the invention is not limited to the configuration. For example, without providing the ROM 46, and a trigonometrical function may be computed directly by the DSP.

The computing unit 44 computes the waveform data of the trigonometrical function as a base recorded on the ROM 46, thereby generating the waveforms A to D in FIG. 3, but the invention is not limited to the configuration. For example, the waveforms A to D may be directly stored in place of waveform data of the trigonometrical function as a base into the ROM 46. It is also possible to store only the waveforms A and C and invert the signs of the waveforms A ad C to obtain waveforms B and D.

Although the modulator for performing BPSK has been described in the embodiment, the invention is not limited to the example but can be also applied to a modulator performing QPSK (Quadrature Phase-shift keying). In this case, it is sufficient to increase the number of waveforms to be approximated.

In the embodiment, the modulator for modulating the RDS/RBDS data has been described. The present invention can be also preferably used for the other digital modulations.

While the preferred embodiments of the present invention have been described using specific terms, such description is for illustrative purposes only, and it is to be understood that changes and variations may be made without departing from the sprint or scope of the appended claims.

What is claimed is:

1. A digital modulator that performs PSK (phase-shift keying) on input digital data, filters the data, and outputs the resultant data, comprising:
a data determining unit that determines a combination of two or more continuous values of the input digital data; and
a waveform generator in which a waveform generation rule is set for each of combinations and which sequentially outputs a digital waveform signal on the basis of a waveform generation rule corresponding to the combination determined by the data determining unit.

2. The digital modulator according to claim 1, wherein
the waveform generator includes a memory that records waveform data of a trigonometric function, reads the waveform data of the trigonometric function, performs a predetermined computation on the waveform data in accordance with the combination of the data, and outputs the resultant data.

3. The digital modulator according to claim 2, wherein
the waveform generation rule is specified by linear sum of waveform data of trigonometric functions of different frequencies.

4. The digital modulator according to claim 3, wherein
when the input digital data is 1-bit data of 1 or 0, a combination of continuous two pieces of input digital data is expressed as (D1, D2), and the waveform data of the trigonometric function of a reference frequency is expressed as sin(ωt) (ωt denotes a variable),
the data determining unit determines any of (0, 0), (0, 1), (1, 0), and (1, 1), and
the waveform generation rule that generates the digital waveform signal “y” is specified as follows when α1, α2, and β are constants,
y=α1·sin(ωt) for (0, 0),
y=α2·sin(0.5ωt)+β(sin 1.5ωt) for (0, 1),
y=−α2·sin(0.5ωt)−β(sin 1.5ωt) for (1, 0), and
y=−α1·sin(ωt) for (1, 1).

5. The digital modulator according to claim 4, wherein
α1:α2:β is about 1:1:0.25.

6. The digital modulator according to claim 1, wherein
the input digital data is 1-bit data of 1 or 0, PSK is BPSK (binary PSK), when a cycle signal whose phase is shifted according to the input digital data passes the value 0 every cycle,
each of digital waveform signals generated by the waveform generator is data expressing an interval between time when the cycle signal passes the value 0 in a certain cycle and time when the cycle signal passes the value 0 in the next cycle.

7. The digital modulator according to claim 1, further comprising a differential encoder that differentially encodes a digital signal of one bit, wherein
the data determining unit receives an output of the differential encoder as the input digital data.

8. The digital modulator according to claim 7, wherein
the digital signal of one bit is RDS (Radio Data System)/RBDS (Radio Broadcast Data System) data.

9. The digital modulator according to claim 8, further comprising an amplitude modulator that receives a waveform signal from the waveform generator and modulates a carrier using the waveform signal as a modulation signal.

10. The digital modulator according to claim 9, wherein
the digital modulator is monolithically integrated on a single semiconductor substrate.

11. An FM transmitter comprising:
a stereo modulator that converts an audio signal to a stereo composite signal;
the digital modulator according to claim 9, that receives RDS/RBDS data, performs differential encoding, BPSK, and filtering on the received data, and outputs the resultant data;
an adder that adds an output signal of the digital modulator and the stereo composite signal output from the stereo modulator; and
a frequency modulator that receives an output signal of the adder and modulates a carrier using the received output signal as a modulation signal.

12. An electronic device comprising:
a sound source that outputs an audio signal;
a host processor that generates RDS/RBDS data; and
an FM transmitter according to claim 11, that is connected to the sound source and the host processor via a predetermined bus, receives the audio signal and the RDS/RBDS data, frequency-modulates the data, and outputs the frequency-modulated data.

13. A digital modulating method comprising:
determining a combination of two or more continuous values of the input digital data; and
selecting a waveform generation rule corresponding to the determined combination from waveform generation rules which are set for combinations, and generating a digital waveform signal on the basis of the selected waveform generation rule.
